(19) United States
(12) Patent Application Publication
(10) Pub. No.: US 2021/0293034 A1
(43) Pub. Date: Sep. 23, 2021

(54) PLASTERING MACHINE WITH A HANDLE, AND A METHOD FOR OPERATING THE PLASTERING MACHINE

(71) Applicant: PROJEKTSELSKABET AF DEN 18 FEBRUAR 2015 APS, Thisted (DK)

(72) Inventor: Hans KLOSTER, Thisted (DK)

(73) Assignee: PROJEKTSELSKABET AF DEN 18 FEBRUAR 2015 APS, Thisted (DK)

(21) Appl. No.: 16/335,213

(22) PCT Filed: Apr. 19, 2017
(86) PCT No.: PCT/EP2017/059272

§ 371 Date: Mar. 20, 2019

(30) Foreign Application Priority Data
Apr. 19, 2016 (DK) PA201670240

(51) Int. Cl. E04F 21/08; B05C 5/02; B05C 11/10

(52) U.S. Cl. CPC E04F 21/08; E04F 13/02; B05C 11/101; B05C 5/0225

(57) ABSTRACT

The invention relates to a plastering machine for applying a surface coating layer to a building surface, such as to a in building wall (1), comprising: a coating material supply (20) connected to a mouthpiece (30) via a flexible hose (15), said mouthpiece (30) including a rear wall (31) connected to a first side flange (34′) and to a second side flange (34″) opposite said first side flange (34′), characterised in at least said first side flange (34′) comprising a first spacer device (40′) defining together with said rear wall (31) a part of a coating material chamber (8), a discharge area (37) for coating material contained in said chamber (8) extending between said opposite side flanges (34′, 34″), said first spacer device (40′) being releasably connected to said first flange (34′).

### FIELD OF THE INVENTION

The present invention relates to plastering machines for applying a surface coating, such as an aggregate cementitious surface coating, to a building structure, in particular to the surface of an exterior or interior building wall.

### BACKGROUND OF THE INVENTION

It is known to form an exposed building surface finish by applying cementitious slurry in a troweling procedure using a handheld trowel connected to a slurry supply via a hose, see by way of example CA patent 1135572, US 2014/0057059 and U.S. Pat. No. 3,319,283.

Also, automated procedures involving plastering machines with floor mounted frames supporting mouthpieces have been developed. Illustrative examples of such plastering machines are disclosed in WO2012028156, FR 1 211 570 and CN patent 2506728.

Tools for the particular procedure with which the present invention is concerned differ fundamentally in size and operation from tools for filling joints and minor depressions in wall boards, such as the tool disclosed in U.S. Pat. No. 2,711,098 which is designed to be held with one hand using a handle with an internal supply conduit for supplying mastic to an applicator mouthpiece.

When applying a coating material to a building surface it is important to ensure a substantially uniform thickness of the resulting coating. Where a frame supporting a mouthpiece and arranged at a certain fixed position from a building wall is used, as in the aforementioned WO2012028156,FR 1 211 570 and CN patent 2506728 publications, this leads to problems where the building wall is not completely vertical. Likewise, where a handheld trowel as illustrated in CA patent 1135572 is used great skills are required as the worker must manually maintain the mouthpiece at a certain distance from the wall surface.

U.S. Pat. No. 3,319,283, upon which the preamble of claim 1 is based, shows a plastering machine with a handheld mouthpiece. This prior art mouthpiece has several disadvantages: for one it cannot be operated near the building floor without holding the supply line horizontally which will shut off the material supply. Furthermore, for practical purposes this prior art mouthpiece is cumbersome in use and cannot be reliably held against the building surface.

Thus, with any of the aforementioned tools there are practical problems which are believed to be the cause of builders tending to prefer reliance on the conventional hard work and inefficient procedures where coatings are built up using a trowel dipped in a plaster containing bucket and then used to manually transfer plaster to the building wall surface.

### BRIEF SUMMARY OF THE INVENTION

The object of the present invention is to provide a plastering machine which is suitable for obtaining a uniform coating thickness and which at the same time alleviates the hard work involved in the conventional troweling procedures. The invention is also useful for applying contiguous neighboring runs of coating material to a building wall.

The above advantages are achieved by the plastering machine defined in the characterizing clause of claim 1 whereby it is ensured that the mouthpiece may be pressed efficiently against the building surface, thus reducing the risk of significant sideways leaks of plaster contained in the mouthpiece while at the same time less restricted operation of the mouthpiece both a high and low levels is made possible; taking into account the weight of the coating material contained in the mouthpiece and the general resistance to free movement of the mouthpiece where a supply hose is connected directly to the mouthpiece the combined effect of the claimed features allows for a solution of the aforementioned problems of the prior art plastering machines.

The design of the mouthpiece as defined in dependent claims is such that plaster can be applied without leaving a narrow groove between adjacent runs, thus avoiding a problem with the machine of U.S. Pat. No. 3,319,283 due to the design of the runners that form part of the mouthpiece and form a narrow groove or furrow must be filled subsequently.

By the spacer device(s) being reconnectable the mouthpiece may be brought back to its initial configuration for later use at another site. Many different ways of providing this reconnectability may be readily contemplated and will fall within the scope of the present claims.

In one embodiment first and/or second spacer devices may be used having a plurality of abutment faces arranged in spaced apart relationship in a direction from a bottom portion to a top portion of the mouthpiece. This allows the mouthpiece to provide a coating layer of a highly uniform thickness since small irregularities in the building surface will not give rise to any strong rocking movements of the mouthpiece as it is moved.

The invention also relates to a method of operating an embodiment of the plastering machine where the mouthpiece defines an inspection opening at the top portion thereof, for visually inspecting the level of the coating material. According to this method the mouthpiece is moved upwards to discharge the coating material, the speed with which the mouthpiece is moved upwardly manually by the worker holding the handle being adjusted to maintain a level of the material in the recess corresponding essentially to a selected level.

Preferred embodiments of the claimed invention are defined in the dependent claims.

While the plastering machine as defined in the appended claims includes a coating material supply and a first conduit portion it will be understood that independent claim(s) may be drawn up in respect to the mouthpiece with i) the handle and ii) the second conduit portion, the coating material supply, which may be in the form of a container and pump, being secondary/auxiliary equipment.

Embodiments of the invention will now be described, by way of example only, with reference to the accompanying drawings, as follows;

FIG. 1 is a perspective view of a machine according to the invention,

FIG. 2a is a perspective view of a mouthpiece for the machine, with certain parts illustrated as being transparent,

FIG. 2b is a cross-sectional view of the device of FIG. 2a, seen along line 2b in FIG. 2a,

FIGS. 3a and 3b are rear side views of embodiments of the mouthpiece of FIG. 2a, in two different configurations,

FIG. 4 is a view similar to FIG. 2a, with the mouthpiece in a first configuration and at the start of application of a run of plaster,

FIG. 5 is a view similar to FIG. 4 when finalizing the run of coating material,

FIGS. 6 and 7 show a further embodiment, in opposite views,

FIG. 8 is a perspective view of a hollow portion of the conduit leading material to the mouthpiece,

FIG. 9 is a cross-sectional view of the hollow portion shown in FIG. 8,

FIGS. 10 and 11 show another embodiment of the mouthpiece in various configurations,

FIGS. 12-14 show the mouthpiece of FIG. 10 in various configurations, during connection of the hollow portion of FIG. 8,

FIG. 15 shows a worker gripping around gripping portions of the handle with his hand, and

FIG. 16 shows, schematically, variations of the design of the mouthpiece 30 according to the invention.

### BRIEF DESCRIPTION OF THE DRAWINGS

FIG. 1 shows schematically a building wall 1, such as a brick or concrete wall, in the process of having a part of its surface being covered with a first or initial run 5 of a coating material, using the plastering machine 10 of the present invention. The plastering machine 10 comprises a coating material pump 20, preferably configured for being positioned on a base near the building wall 1, a conduit including a flexible hose 15, and a work-piece in the form of a mouthpiece 30 which is connected to the conduit and to which is rigidly connected a handle 39 allowing a worker (not shown) with his hands to hold the mouthpiece 30 firmly against the surface of the building wall 1 (see FIG. 15).

By holding the mouthpiece 30 firmly against the wall 1, and through the design of the mouthpiece 30, it is ensured that during the coating procedure substantially no coating material will leave the mouthpiece in a sideway direction perpendicular to the extension of the run 5. Coating material of a relatively high viscosity (higher than that of a slurry with a very high water content) may preferably be used.

On activation of the pump 20 coating material, in the following for simplicity referred to as “plaster”, is delivered from the pump 20 via the aforementioned conduit to a plaster material chamber 8′ defined by the building wall 1 together with a recess 8 of the mouthpiece 30, see FIGS. 2a and 2b. By continuously moving the mouthpiece 30 in an upward direction until reaching the upper edge of the surface of the building wall 1, which may be defined by a building ceiling (not shown), the run 5 of plaster is deposited on the building wall 1, the width of the run 5 corresponding to a length of a discharge gap 80 at a bottom portion B of the mouthpiece 30, as will be explained, and the thickness of the run 5 corresponding to the width of the discharge gap 80 and being typically in the order of 4 mm-8 mm. Activation of the pump 20 may be through switches/contacts incorporated in the handle 39, preferably wirelessly.

FIG. 2a shows one embodiment of the mouthpiece 30 in greater details and in a second configuration thereof; a rear wall 31 of the mouthpiece 30 closest to the worker is shown as being transparent to make visible certain parts of the mouthpiece 30, as well as the plaster material chamber 8′. Normally, the mouthpiece 30 will be of a non-transparent material, of metal or a sturdy plastic material. Opposite the bottom portion B of the mouthpiece 30, at a top portion T thereof, is an inspection opening 36. Connected to the rear wall 31 are a first side wall 31′ and an opposite second side wall 31″.

As seen in FIG. 2a, the hose 15 defines a first portion of the conduit while a second portion 150 of the conduit serves for connecting the hose 15 to the mouthpiece 30. The mouthpiece 30 has a flow passage 120 for the plaster, at the entry of which passage 120 the mouthpiece 30 has a first connector 160 for connection with a second connector 170 mounted to the second portion 150 of the conduit. In itself the second portion 150 of the conduit includes one or two swivel joints 180, 190 configured for rotation about a first axis and a second axis, respectively. The second portion 150 of the conduit will be described in further details below.

Plaster enters the aforementioned chamber 8′ via a bifurcation with two branches 121, 122 of the flow passage 120, through two entry openings 32 seen best in FIG. 3a. It will be understood that—in operation—the chamber 8′ is normally filled with a fresh mass of plaster (not shown in FIG. 2a), a portion of this mass closest to the building wall 1 being at any time instantly in the process of bonding to the surface of the building wall 1.

In operation, as the mouthpiece 30 carried by the worker is moved upwards to discharge an amount of plaster through the discharge gap 80 at the bottom portion B thereof the pump 20 and the speed with which the mouthpiece 30 is moved upwardly along the wall 1 is preferably adjusted to maintain the level of plaster material in the chamber 8′ corresponding essentially to the level of the inspection opening 36, or to any other selected level within the chamber 8′.

As seen in FIGS. 2a, 3a and 3b the two opposite side walls 31′, 31″ each include a flange, in the following referred to as the first flange 34′ and the second flange 34″, respectively. The flanges 34′, 34″ are oriented away from the recess 8 and may as such present respective surfaces that may be pressed directly against the building wall 1. However, preferably, the first flange 34′ is configured for supporting at least one spacer device, to be discussed below, which slides against the building surface in use of the plastering machine 10.

Shown in FIG. 2a is how the first flange 34′ (on the side facing away from the worker) carries a first, preferably elongated spacer device 40′ having oriented to the left in FIG. 2a a longitudinal (vertical) edge F′ delimiting a part of the plaster material chamber 8′ nearest the building wall 1. This first spacer device 40′ is releasably connected to the first flange 34′, in the shown embodiment by screws, allowing removal thereof from the mouthpiece 30. Preferably, as shown, the second side flange 34″ has a second spacer device 40″ attached thereto, having oriented to the right in FIG. 2a a longitudinal (vertical) edge F″, which may be partially defined by a flexible blade seal, and delimiting also the part of the plaster material chamber 8′ nearest the building wall 1. Preferably at least the first spacer device 40′ is reconnectable to the first flange 34′ in its original position, such as by screws, clamps, by a snap connection, or by other complementary coupling elements. The spacer devices 40′, 40″ serve i.a. to define the thickness of the layer of plaster applied to the building surface, and may be configured for replacement when worn down.

As seen best in FIGS. 2b and 16, when the mouthpiece 30 is held against the building wall 1 the plaster material chamber 8′ is defined jointly by the building wall 1 and the mouthpiece 30. The discharge gap 80 extends between the opposite side flanges 34′, 34″, between lower portions of the opposed inner edges F′, F″ of the spacer devices 40′, 40″, and is delimited along its length on the one hand by a lower edge 37 of the rear wall 31 and on the other hand by the building wall 1. For keeping the lower edge 37 spaced from the building surface 1 to define the material discharge the spacer devices 40′, 40″ have a number of faces 38 abutting against the building surface 1. The thickness of the applied run 5, 5′ depends on spacers discussed herein and selected for the mouthpiece 30, which spacers determine the distance at which the lower edge 37 will be kept from the building surface 1.

Shown in FIGS. 2a, 3a and 3b is also a top flange 35 defining the top portion T of the mouthpiece opposite the gap 80 and connecting the opposite side walls 31′, 31″. This top flange 35 and/or the rear wall 31 carries near the first spacer device 40′ a third spacer device 42 which may or may not be releasably connected to the mouthpiece 30. The top flange 35 may extend down to the discharge gap 80 to delimit the chamber 8′ in a part thereof closest to the building wall 1.

While the spacer devices 40′, 40″ may along their entire length from top portion T to bottom portion B have a flat abutment face 38 being pressed against the building surface an alternative form shown in FIG. 3a may also be foreseen. Here the elongated spacer devices 40′, 40″ each have a recessed area between their respective ends such that contact with the building surface is only locally, here at the two ends 38 of the first and second spacer device 40′, 40″, with an elongated flexible blade seal (shown in FIG. 3b) as mentioned above optionally extending along the recessed area. This allows the mouthpiece 30 to provide a coating layer of a highly uniform thickness since small irregularities in the building surface may otherwise give rise to strong a rocking movement of the mouthpiece 30 as it is moved. It will be understood that for low viscosity plaster material the recessed area should preferably be shallow or avoided, or preferably have a blade seal. The flexible blade seal has a first surface and an opposite second surface, the first surface being oriented towards the material contained in the recess 8 when the flexible seal is placed against the building surface/wall 1 in use of the machine 10. In this manner a self-sealing effect is achieved in that the material in the recess 8/chamber 8′ presses the aforementioned second surface against the building surface 1.

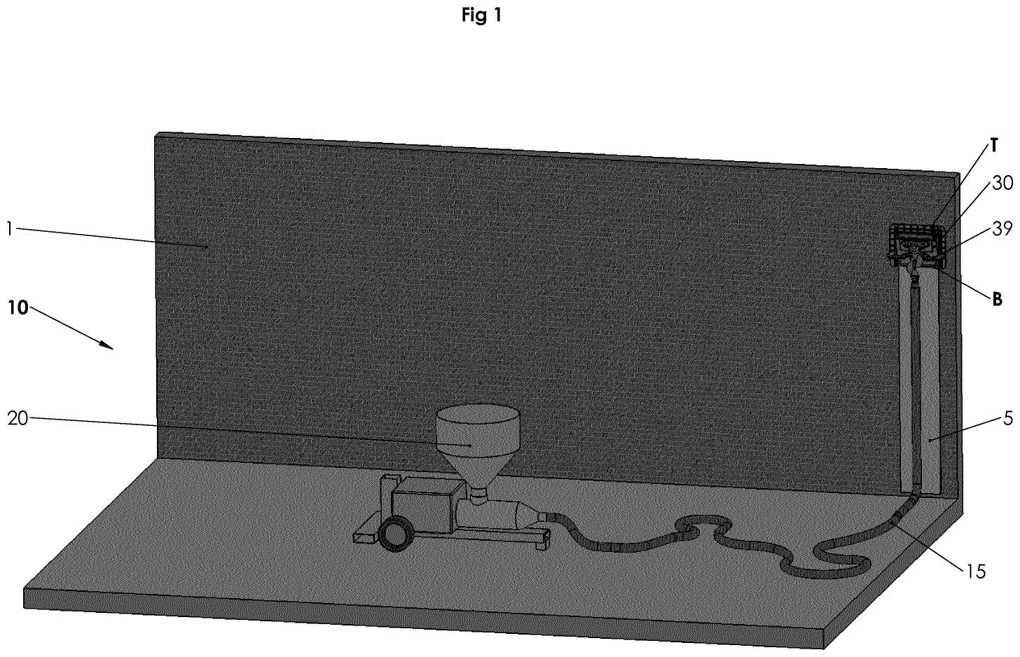

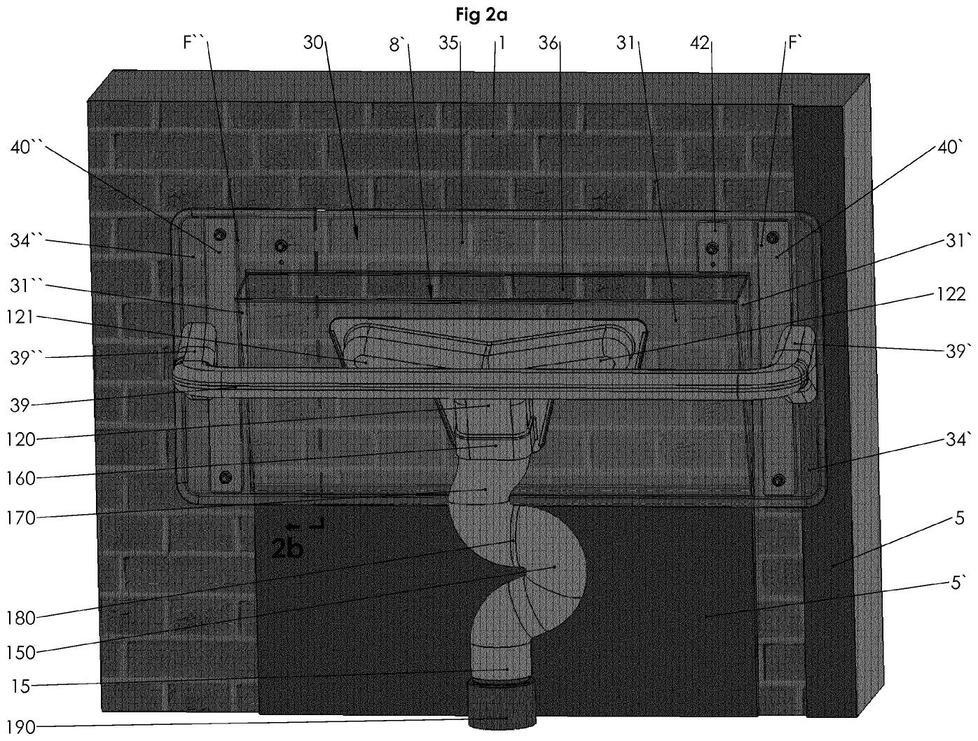

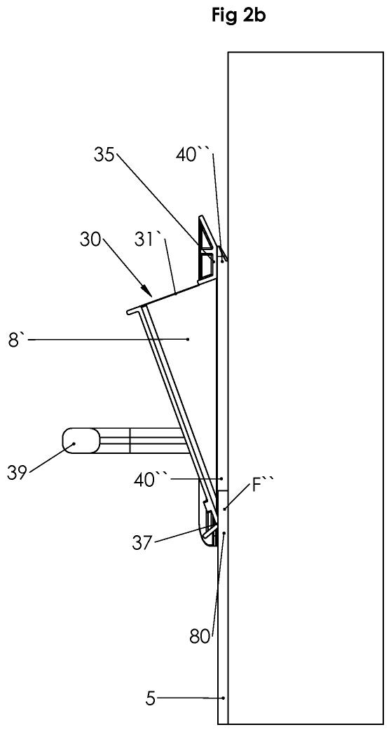

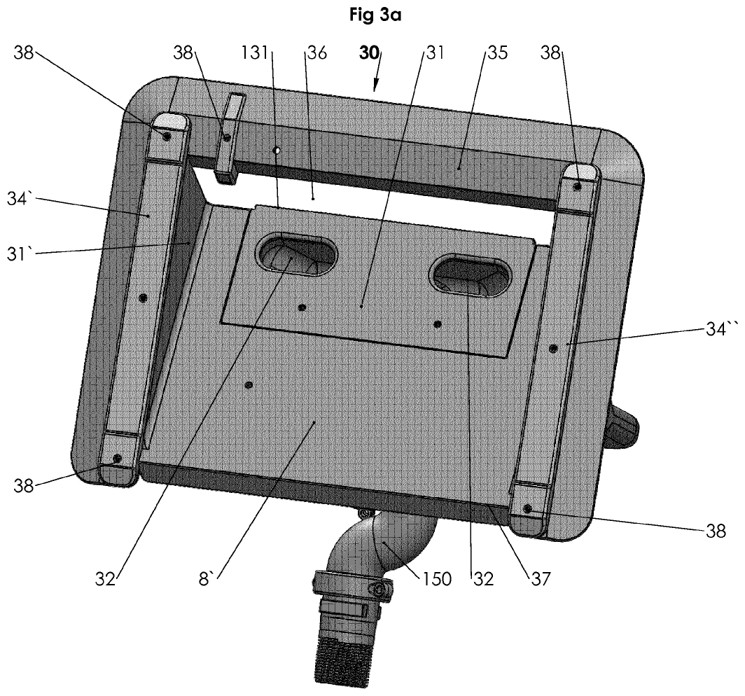

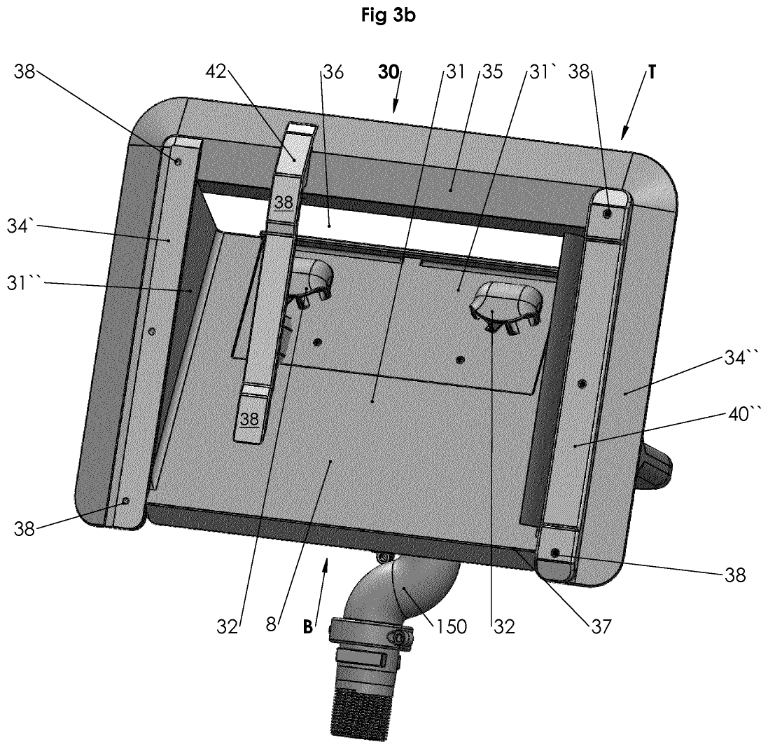

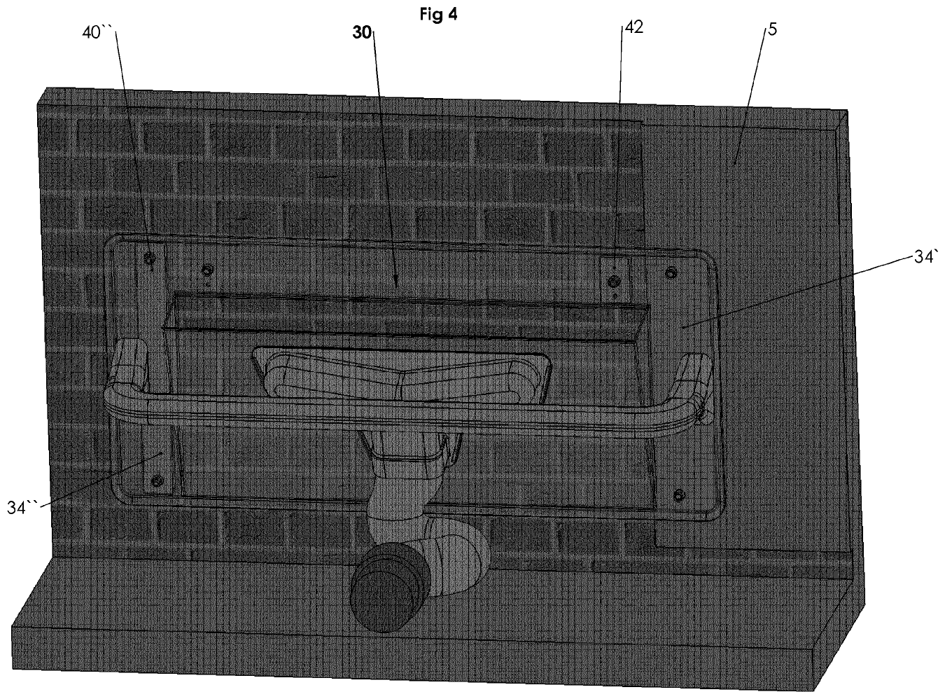

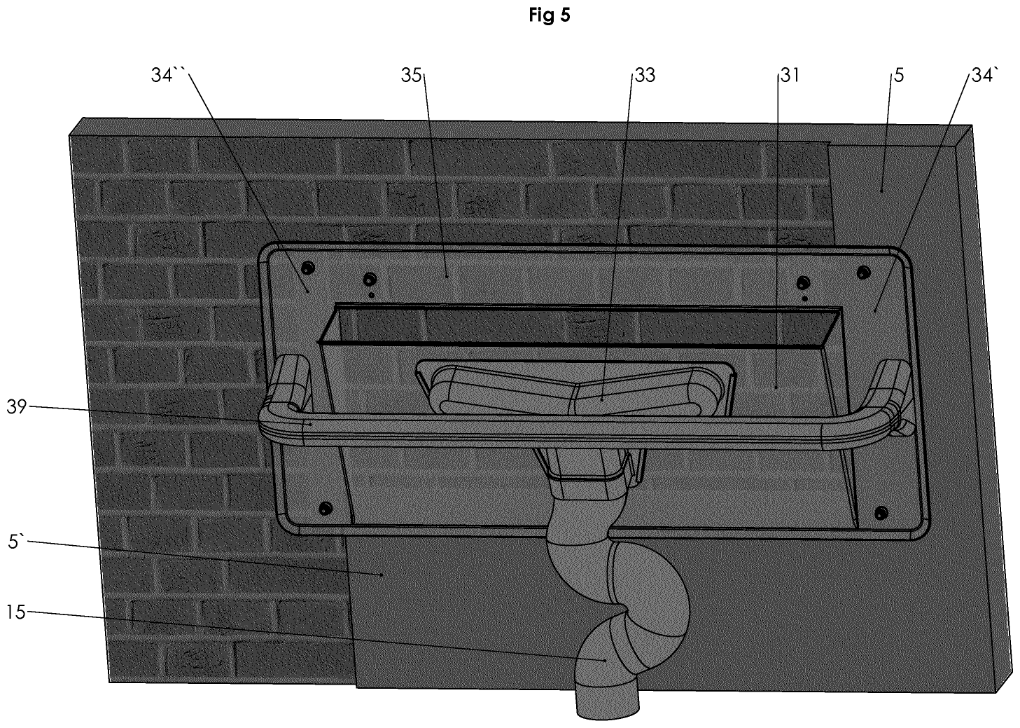

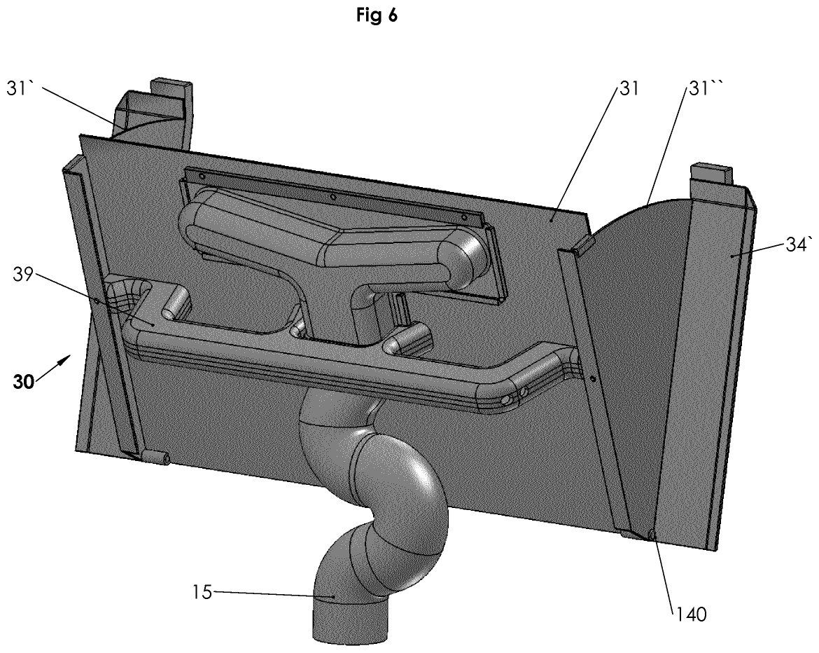

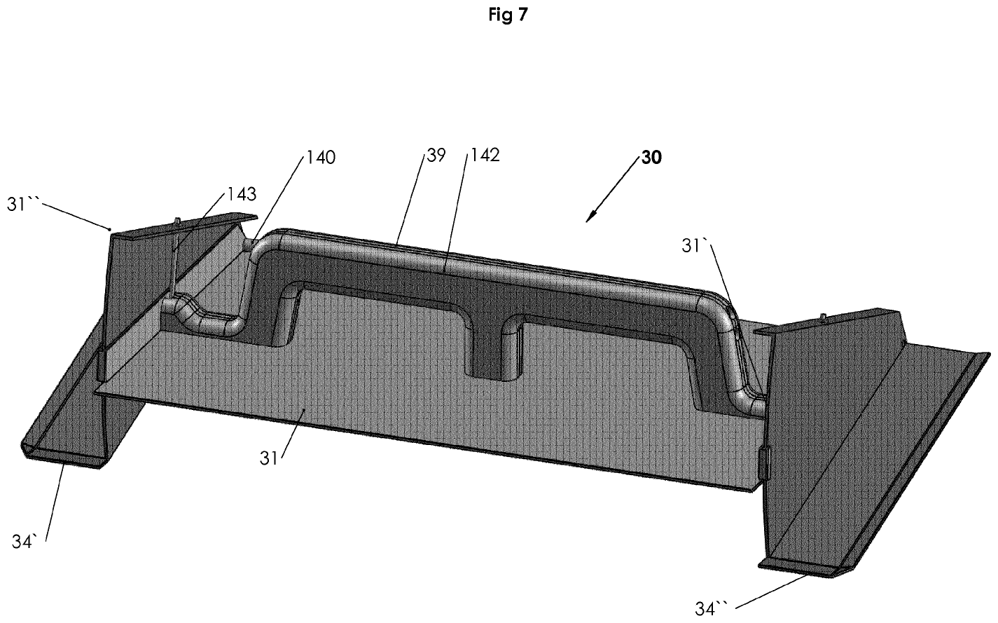

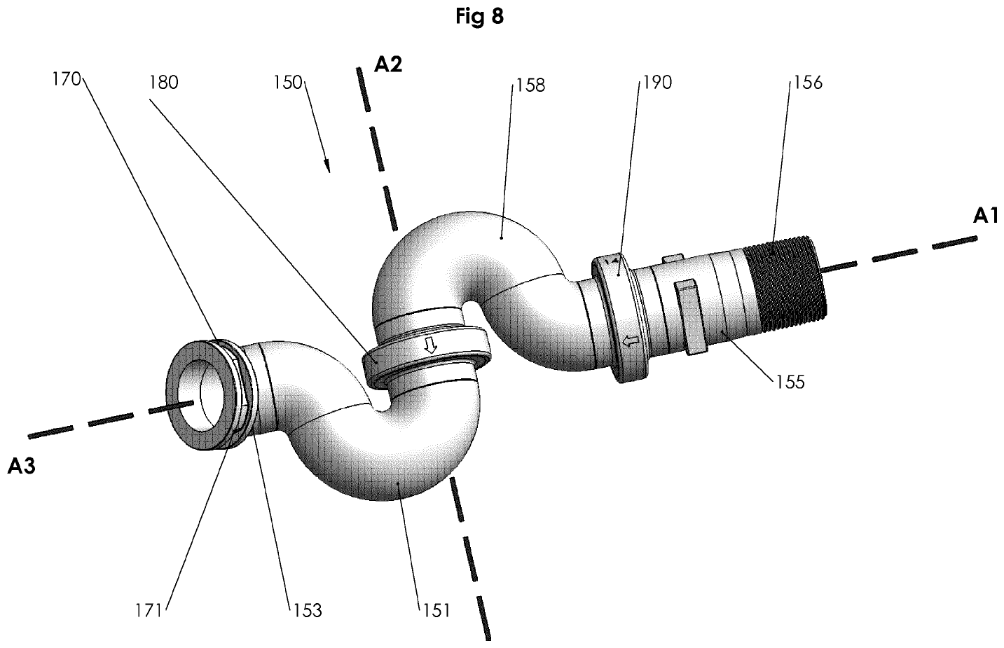

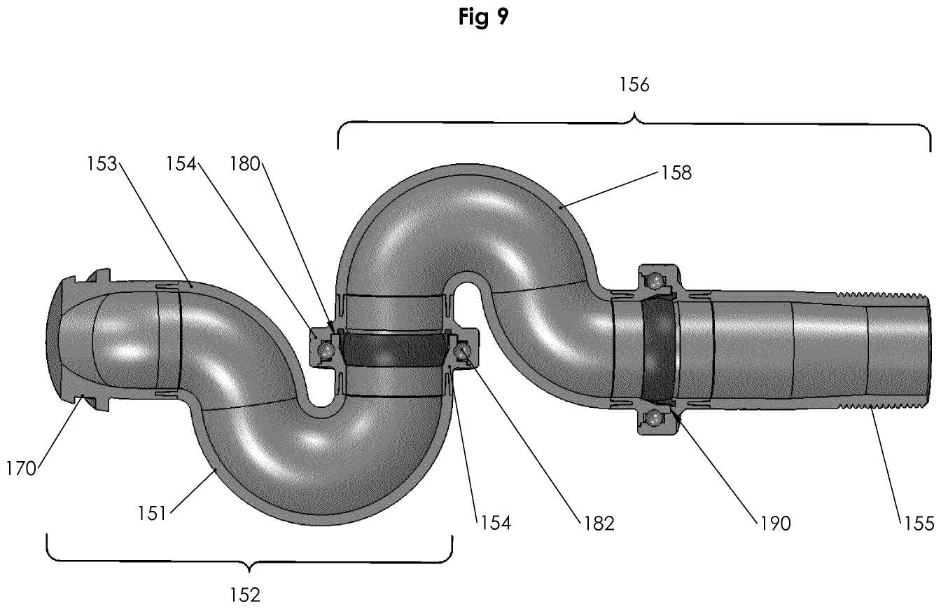

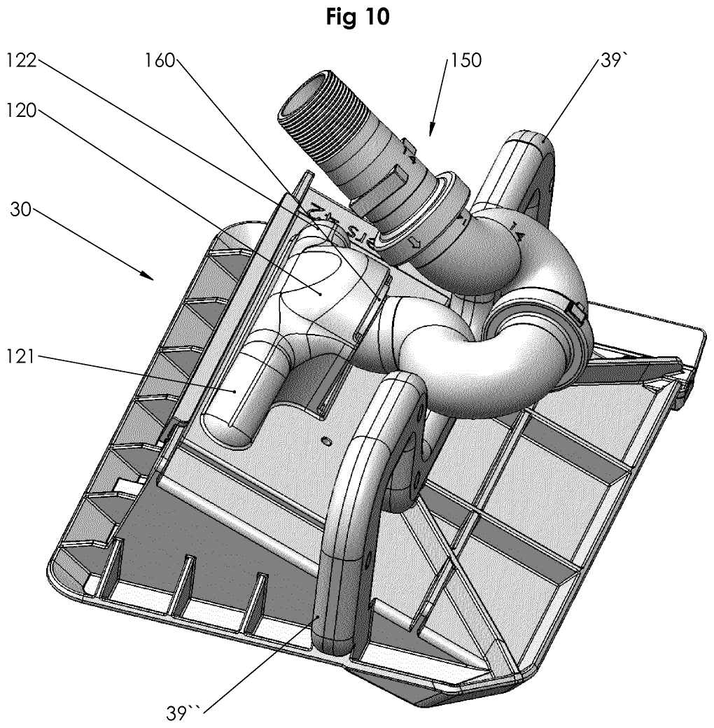

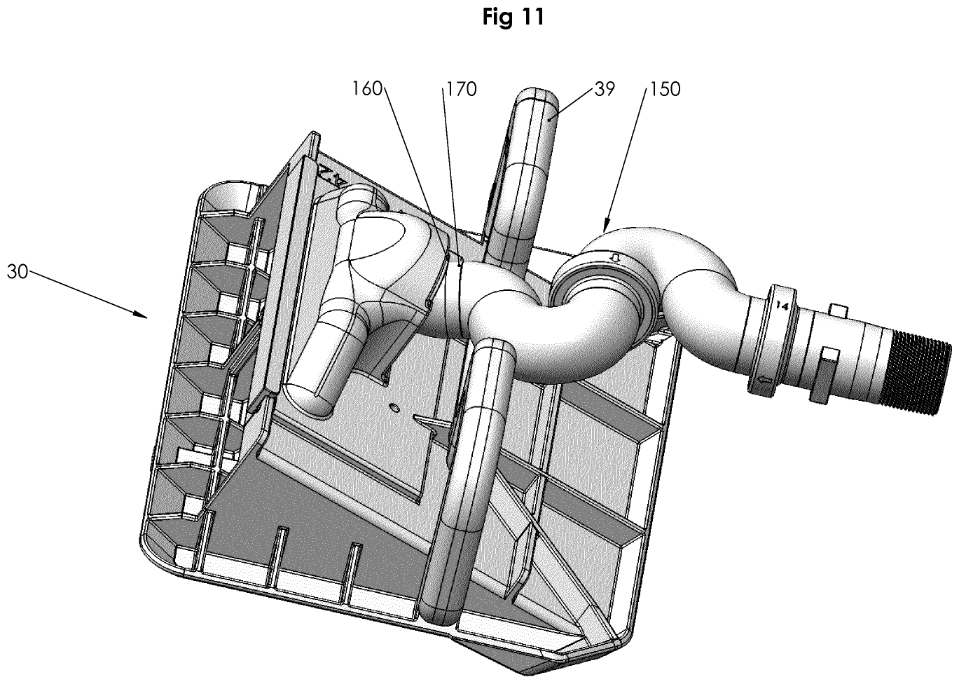

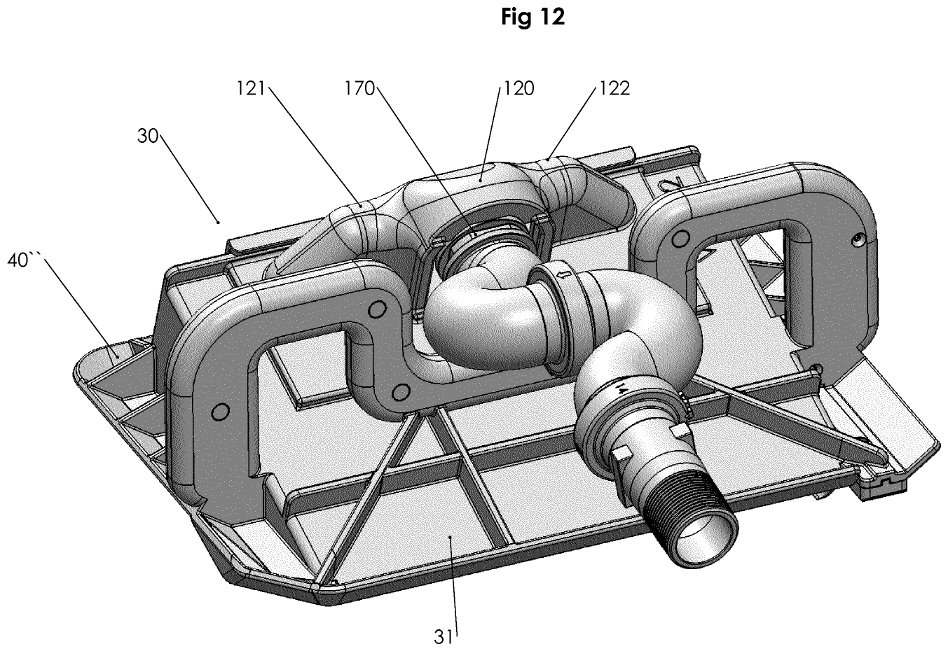

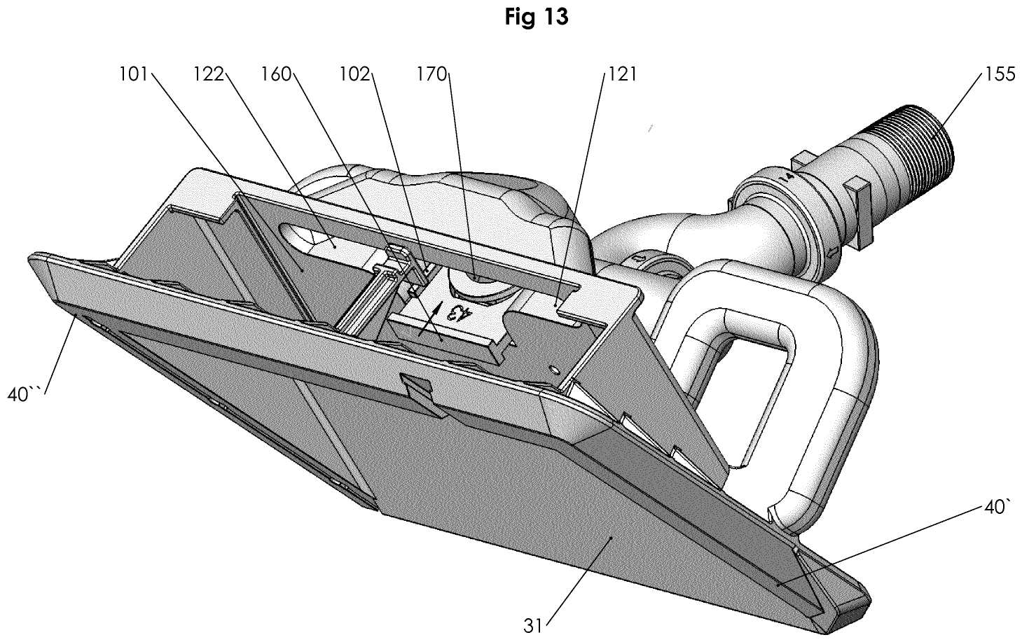

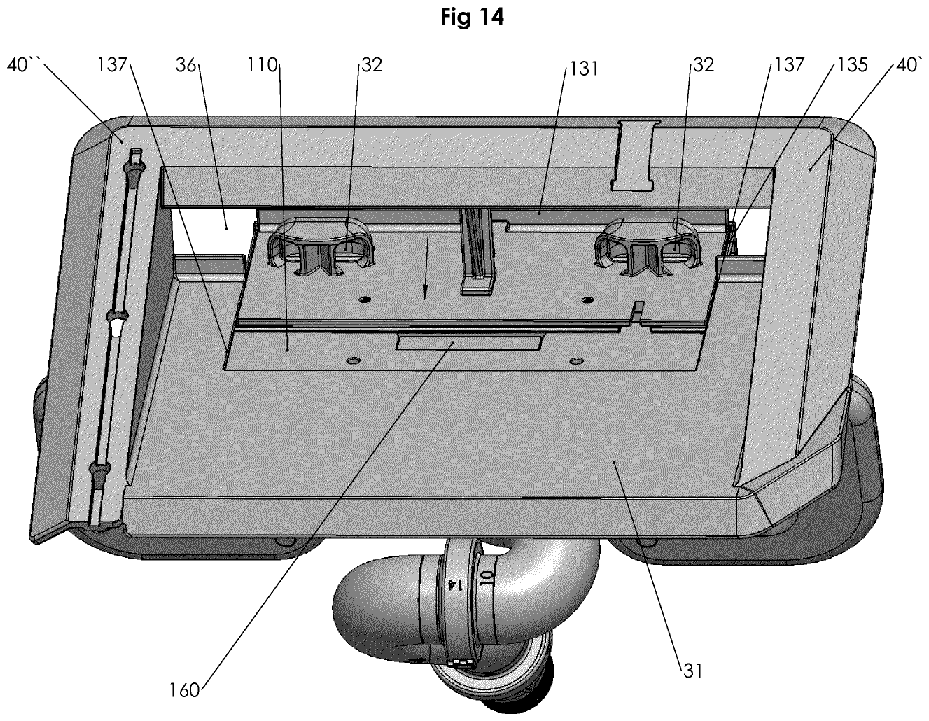

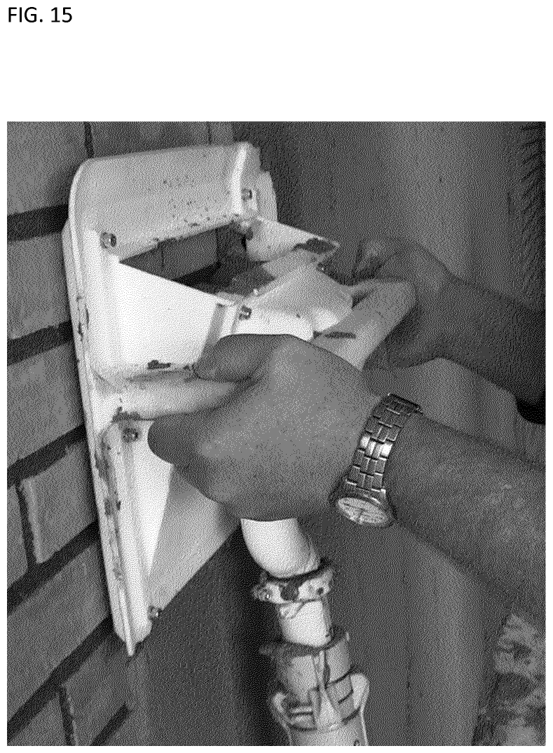

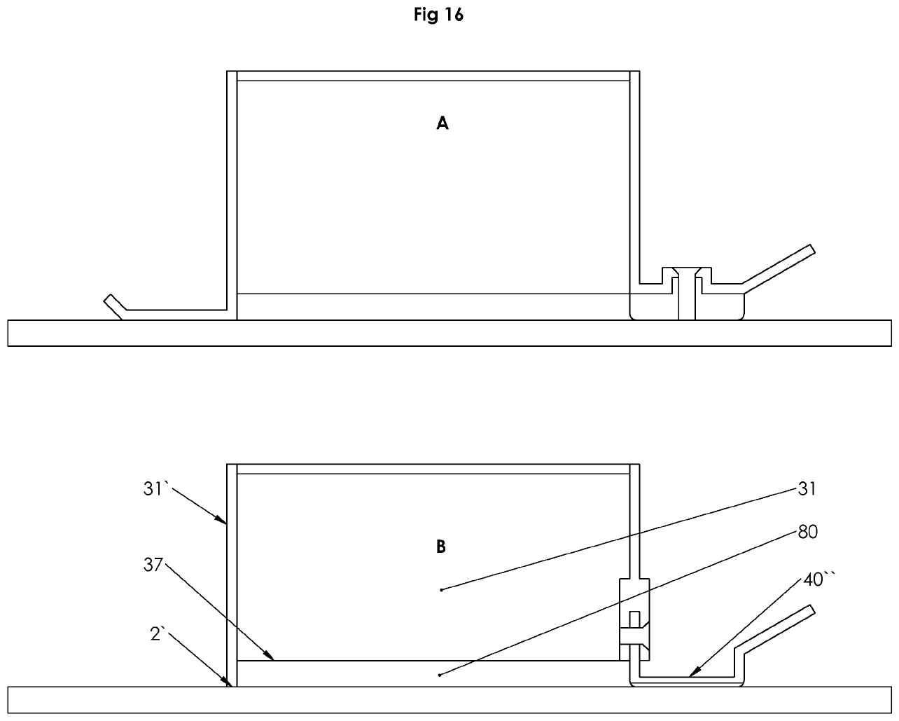

The invention may allow for application of plaster in different manners, i) for application of two contiguous neighboring runs 5, 5′ of plaster as shown in FIG. 5 wherein the mouthpiece is operated in a first configuration, and iia) for application of two non-contiguous neighboring runs 5, 5′ as shown in FIG. 2a or iib) for application of a first run 5 as shown in FIGS. 1 and 3a, wherein the mouthpiece is in an second configuration, following application of which first run 5 the mouthpiece 30 is brought into the aforementioned first configuration by removing the spacer device 40′.

FIG. 3b shows a slight variation of the mouthpiece 30 of FIG. 3a, in the aforementioned first configuration with the first spacer device 40′ removed, exposing the surface of the first flange 34′, which surface may glide against the surface of a previously applied run 5. In this particular embodiment the third spacer device 42, mounted to the flange 35 and to the rear wall 31 in a position closer to the first flange 34′ than to the second flange 34″ (eg. between the first flange 34′ and the first connector 160), extends in the recess 8/chamber 8′ towards the lower edge 37, with its tip having a face 38 located below the level of the entry openings 32. This is of particular advantage where the handle 39 is rigidly connected to the side walls (31′, 31″) at a position well below the entry openings 32 to provide a good balancing of the work load and to enable the worker to provide an even pressure against the building surface 1, by the tip of the third spacer device 42 abutting directly against the building surface 1. The position of the third spacer device 42 face 38 is selected to provide for a proper balancing of the mouthpiece 30 as it is held by the worker against the building surface, hereby keeping through the simultaneous abutment of the faces 38 with the building surface 1 the desired gap between the lower edge 37 and the building surface 1.

Preferably, as shown in FIG. 3b, the second spacer device 40″ may have a flexible blade seal as mentioned above.

As shown, a symmetrical rib connecting the third spacer device 42 with the rear wall 31 has a surface configured to allow the inflowing material to flow around the rib such that the recess 8 is filled uniformly with the coating material at the level of the lower edge 37.

In some cases, such as where the first run 5 of material is applied with the first flange 34′ of the mouthpiece 30 being close to or edgewise abutting a wall structure (not shown) perpendicular to building wall 1, sideways leak of coating material from the mouthpiece 30 at the first flange 34′ may not be an issue or need not be avoided when applying the first run 5. In this case the mouthpiece may be configured and operated at all time in the first configuration shown in FIG. 3b, without use of any first spacer device 40′ mounted to the first flange 34′.

It is foreseen that normal operation will be for applying contiguous runs 5, 5′ of plaster since applying non-contiguous runs of plaster 5, 5′ as shown in FIG. 2a will normally not be desirable. Hence, in the normal operation, immediately before applying the second and further, contiguous neighboring runs 5′ of plaster the workman removes the first spacer device 40′ (after having applied the first run 5 with the mouthpiece in the second configuration shown in FIG. 2a) and applies the second run 5′ while holding the inner face of the first flange 34′ close to or in contact with the surface of the first run 5, as shown in FIGS. 4 and 5. It will be clear the runs 5, 5′ may be applied vertically, or eg. horizontally.

FIG. 4 again shows the rear wall 31 as transparent to illustrate that the second spacer device 40″, and preferably also the third spacer device 42 remains connected to the flange 34″ of the second side wall 31″ and to the top flange 35 in the aforementioned first configuration of the mouthpiece 30. Since the width of the discharge gap 80 corresponds to the thickness of the first run 5 sideways leakage of plaster material from the chamber 8′ is prevented or restricted by the edge F″ of the second spacer device 40″, such as by the flexible blade seal shown in FIG. 3b, on the one hand and by the vertical edge of the first run 5 on the other hand.

While the width of the discharge gap 80 could in principle be maintained/kept by the second spacer device 40″ abutting the building wall 1 and the flange 34′ of the first side wall 31′ abutting the surface of the first run 5, i.e. without the use of the third spacer device 42 (i.e. as shown in FIG. 3a), it is preferred to rely on the third spacer device 42 rather than on the first side wall 31′ flange 34′ for this purpose. This is because applying a full force by the first side wall 31′ flange 34′ against freshly applied plaster of the first run 5, perpendicularly to the surface thereof, may damage the plaster. Since the mouthpiece 30 is moved in an upward direction a support against the building wall 1 by the second spacer device 40″ and the third spacer device 42 extending in the recess 8, i.e. with no support against the building wall 1 in the lower right hand side corner of the mouthpiece 30, as shown in FIG. 4, has been shown to work fine, and this in particular where the handle 39 is connected to the side walls 31′, 31″ or to the flanges 34′, 34″ closer to the bottom portion B below entry openings 32 for entry into the recess 8 of the coating material.

In summary, by providing according to one embodiment of the invention a mouthpiece 30 that may be brought into at least two different configurations it is made possible to apply contiguous neighboring runs of plaster material to a building wall 1, preventing sideways leakage of plaster material in the aforementioned chamber 8′ by relying in the first configuration inter alia on the face F″ of the second spacer device 40″ and the longitudinal edge of a run 5 of plaster already applied to the wall using the mouthpiece 30.

It is noted that the spacer devices 40′, 40″, 42 may preferably be made from a plastics material, providing a relatively low friction against the surface of the building wall 1 and allowing for complete replacement. Since a worker may prefer to apply further runs 5′ to the right or left of a first run 5 it is contemplated that both spacer devices 40′, 40″ preferably should by reconnectable; however, in one embodiment one spacer device 40″ may be an integral part of the corresponding flange 34″.

It is also noted that the aforementioned third spacer device 42 may be provided by the first spacer device 40′ having been moved, such as by a pivotal movement, into the position mentioned above in respect to the third spacer device 42. Finally, the vertical length of the spacer devices 40′, 40″ may be selected as desired; thus even very short spacer devices may be contemplated.

While for some embodiments the rear wall 31 includes opposite sides 31′, 31″, each being contiguous with a respective one of the opposite flanges 34′, 34″ FIGS. 6 and 7 show an alternative embodiment wherein the rear wall 31 is pivotally connected to the opposite sides 31′, 31″ by means of a hinge 140. Preferably, a spring mechanism 142 coupled to the rear wall 31 and side flange 31″ by a wire 143, by may be provided, such as inside the handle 39, to bias the rear wall 31 to the position shown in FIG. 6 wherein the chamber 8′ has its maximum capacity. Keeping the flanges 34′, 34″ pressed against the building wall 1 while forcing the rear wall 31 to turn about the hinge 140 axis against the force of the spring mechanism 142 may serve to drive plaster out of the chamber 8′ through gap 37. In FIG. 7 the openings 32 and the aforementioned bifurcation are not shown.

The aforementioned second portion 150 of the conduit will now be described in details with reference to FIG. 8. As shown, the second portion 150 includes two subparts referenced in the cross-sectional view of FIG. 9 by numerals 152 and 156, respectively, and defining an internal flow passage through which coating material is supplied to the mouthpiece 30. As discussed above the mouthpiece 30 has a first connector 160 which is arranged along a centre line of the mouthpiece and is connected to a second connector 170 which in the shown embodiment is integral with the subpart 152.

Each subpart 152, 156 has a shape preferably resembling the body of a question-mark; thus, subpart 152 has a straight section 153 contiguous with a U-shaped section 151 while subpart 156 has a U-shaped section 158 contiguous with a straight section 155 having a portion 156 which is treaded or otherwise configured for being connected to one end of the flexible (bendable) hose that defines the first portion 15 of the conduit joining the mouthpiece 30 with the coating material supply 20. The two U-shaped sections 152, 158 are rotatably connected at swivel joint 180, such as through a ring-structure engaging flanges 154 at the respective ends of the U-shaped-sections, with an O-ring (not shown) provided as required to establish a seal. Alternatively, as shown, each of the flanges 154 may have annular recesses formed in opposed wall portions, whereby the two U-shaped sections 151, 158 are held together by filling, via a filling opening in one or both of the flanges 154, an annular groove defined by the opposed recesses with metal or other material bearing balls 182. In this manner rotation about a swivel axis A2 of the two subparts 152, 156 relative to one another is enabled, as shown in FIGS. 10 and 11, whereby the mouthpiece 30 may be applied against the building wall 1 near the base with the subpart 156 rotated outwards, as illustrated in FIGS. 4, reducing the risk of kinking of the flexible hose had it been connected directly with the mouthpiece 30.

As shown in FIG. 10, through the shape of the two U-shaped sections 151, 158 the second portion 150 may be back-folded to some extent when the two subparts 152, 156 are rotated relative to one another, without blocking the flow of plaster through the conduit. Preferably, as shown in FIG. 8 the two straight sections 153, 155 extend generally in a common plane perpendicular to the plane of the paper; however, within this common plane the straight section 153 of the subpart 152 connected to the mouthpiece 30 preferably extends at an angle to the U-shaped section 151, i.e. such that an angle is defined between the respective longitudinal axes A1 and A3 of the two straight sections 155, 153. This allows the straight section 153 to extend parallel with the inclined rear wall 31 of the mouthpiece 30, with the remaining part of the second portion 150 extending essentially in a vertical plane when in the configuration shown in FIGS. 1 and 2a. The rear wall 31 is preferably plane and inclined such that the recess 8 tapers in a direction from the top portion T to the bottom portion B, i.e. such that the width of the compartment 8′ measured perpendicularly to the building surface 1 preferably varies linearly.

Preferably, for added flexibility the second portion 150 of the conduit also is structured to include a second swivel joint 190 to allow for a relative rotation between parts of the second portion 150 about another axis A1, such as the aforementioned longitudinal axis A1 of the straight section 155, perpendicular to the swivel axis A2 of the first swivel joint. The second swivel joint 190 may be a structural part of the second portion 150, such as by being configured as a rotatable connection between U-shaped section 158 and straight section 155 of subpart 156; alternatively, the second swivel joint 190 may be defined through the connection between the first and second connectors 160, 170, i.e. where the second portion 150 of the conduit is connected to the mouthpiece 39.

Connection between the first and second connector 160, 170 will now be discussed in further details with reference to FIG. 10 and onwards. FIG. 12 shows structural portions of the two branches 121, 122 of the flow passage 120 of the mouthpiece 30, and illustrates the connector 170 of the second portion 150 of the conduit being inserted into the flow passage 120, for subsequent connection therewith by the second connector 170 engaging the first connector 160 seen in FIG. 11. A recess 101 formed in the rear wall 31, see FIG. 13, defines faces of the aforementioned structural portions of the two branches 121, 122 as well as a groove 102 for receiving the first connector 160 shown here as a slidable fork-like member with two legs thereof being inserted at the same time in the direction of the arrow into a peripheral groove 171 of the second connector 170. This provides for a reliable and releasable securing of the second portion 150 of the conduit to the mouthpiece 30, useful for eg. cleaning the mouthpiece.

FIG. 14 shows a subsequent step wherein after full insertion of the first connector 160 into the groove 102 a plate-like member 131 is slid along the direction of the arrow in opposite tracks defined also along the recess 101.

Sliding this plate-like member 131 into its final position seen in FIG. 3a completes the mounting of the second portion 150 of the conduit to the mouthpiece 30 while at the same time defining together with the recess 101 the two branches 121, 122.

FIG. 15 shows a worker gripping around gripping portions 39′, 39″ of the handle 39 with his hand. The handle 39 according to the invention has such gripping portions 39′, 39″, each gripping portion 39′, 39″ being arranged adjacent, preferably alongside, a respective one of the side walls 31′, 31″, with the gripping portions 39′, 39″ each being for a user to grip around, preferably all around, with his hand and each being rigidly connected to either the flanges 34, 34″ or to the opposite side walls 31′, 31″. The handle 39 is shown for the two embodiments in FIGS. 1 and 10, respectively. For the embodiment of FIG. 10 the handle 39 loops inwardly towards the rear wall 31 with the two gripping portions 39′, 39″ being connected for high stability while allowing the two U-shaped sections 151, 158 of the second portion 150 to be back-folded. As shown, for maximum stability and ability to press the mouthpiece against the building surface each gripping portion 39′, 39″ is connected to a respective flange 34′, 34″.

FIG. 16 shows, schematically, variations of the design of the mouthpiece 30 according to the invention.

The present invention is not limited to the plastering machine shown in FIG. 1; the invention also is related to the mouthpiece as such, as described above, for which independent claims may be drawn up.

1. A plastering machine for applying a surface coating layer to a building surface, such as to a building wall, comprising:
a coating material supply connected to a mouthpiece via a conduit, a flexible hose defining a first portion of said conduit,
said mouthpiece having a top portion (T) and a bottom portion (B) and including:
a rear wall,
a first side wall and
a second side wall opposite said first side wall,
said rear wall being connected to or integral with said first side
wall and said second side wall to define a coating material recess for containing coating material supplied to said mouthpiece through said conduit, said recess preferably tapering in a direction from said top portion (T) to said bottom portion (B),
a lower edge of said rear wall at said bottom portion (B)
being configured to delimit, preferably together with said building surface, an elongated coating material exit, such as a gap, for discharge of said coating material contained in said recess in use of said machine,
wherein
said mouthpiece further including a handle having gripping portions, each gripping portion being arranged adjacent, preferably alongside with, a respective one of said side walls, said gripping portions each being for a user to grip around, preferably all around, with his hand,
said rear wall having a coating material flow passage, said mouthpiece having a first connector, a second portion {150) of said conduit having a second connector for coupling with said first connector, said second portion including a swivel joint configured for rotation about an axis (A2), said axis (A2) preferably being parallel with the extension of said elongated coating material exit, said second portion preferably including two U-shaped or substantially U-shaped sections connected with each other at said swivel joint.

2. The plastering machine of claim 1,
said first side wall including opposite said rear wall a first flange and
said second side wall including opposite said rear wall a second flange,
said first and second flanges being oriented to extend away from said recess.

3. The plastering machine according to the previous claim, each gripping portion being rigidly connected to a respective one of said side walls, preferably to a respective one of said flanges.

4. The plastering machine according to claim 1, at least a first spacer device having a number of faces configured for being placed against said building surface (in use of said machine to keep said lower edge spaced from said building surface by said number of faces abutting against said building surface, said first spacer device being connected, optionally releasably, to said first side wall opposite said rear wall, preferably to said first flange.

5. The plastering machine according to claim 4,
a second spacer device having a face configured for being placed against said building surface in use of said machine,
said second spacer device being connected to said second side wall opposite said rear wall, preferably to said second flange.

6. The plastering machine according to claim 5, said material exit being a gap delimited by said building surface and endwise delimited by said first and second spacer devices.

7. The plastering machine according to claim 4, said connection of said first and/or second spacer device to said respective side wall being by screws, clamps, by a snap connection, or by other complementary coupling elements.

8. The plastering machine according to claim 1, including a spacer device having a face configured for being placed against said building surface in use of said machine, to keep said lower edge spaced from said building surface by said face abutting against said building surface, said spacer device extending in said recess, optionally from said top portion, with said third spacer device face in a position closer to said first flange than to said second flange.

9. The plastering machine according to claim 8, including a third flange connecting said first and second side walls and having said third spacer device.

10. The plastering machine according to claim 1, said first connector being integral with said mouthpiece, said first connector preferably being integral with said rear wall.

11. The plastering machine according to claim 1, said handle being connected to said side walls or to said flanges closer to said bottom portion (B) below entry openings for entry into said recess of said coating material.

12. The plastering machine according to claim 1, said mouthpiece defining an inspection opening at said top portion, for visually inspecting the level of said coating material in said recess.

13. The plastering machine according to claim 5, said first and/or second spacer device having a plurality of said faces arranged in spaced apart relationship in a direction from said bottom portion to said top portion.

14. A method of operating the plastering machine according to claim 12, whereby as the mouthpiece is moved upwards to discharge said coating material, the speed with which the mouthpiece is moved upwardly is adjusted to maintain the level of said material in the recess corresponding essentially to a selected level.

15. The plastering machine according to claim 2, at least a first spacer device having a number of faces configured for being placed against said building surface in use of said machine to keep said lower edge spaced from said building surface by said number of faces abutting against said building surface, said first spacer device being connected, optionally releasably, to said first side wall opposite said rear wall, preferably to said first flange.

16. The plastering machine according to claim 5, said connection of said first and/or second spacer device to said respective side wall being by screws, clamps, by a snap connection, or by other complementary coupling elements.

17. The plastering machine according to claim 6, said connection of said first and/or second spacer device to said respective side wall being by screws, clamps, by a snap connection, or by other complementary coupling elements.

18. The plastering machine according to claim 2, including a spacer device having a face configured for being placed against said building surface in use of said machine, to keep said lower edge spaced from said building surface by said face abutting against said building surface, said spacer device extending in said recess, optionally from said top portion (T), with said third spacer device face in a position closer to said first flange than to said second flange.

19. The plastering machine according to claim 2, said first connector being integral with said mouthpiece, said first connector preferably being integral with said rear wall.

20. The plastering machine according to claim 2, said handle being connected to said side walls or to said flanges closer to said bottom portion (B) below entry openings for entry into said recess of said coating material.
